(19) United States
(12) Patent Application Publication
(10) Pub. No.: US 2006/0164403 A1
(43) Pub. Date: Jul. 27, 2006

(54) Operator control element for electronic equipment used for actuating sensors and a method for selecting functions contained in an electronic memory and for displaying the selected function using a cursor

(76) Inventor: Oliver Volckers, Trier (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/526,996

(22) PCT Filed: Sep. 11, 2003
(86) PCT No.: PCT/EP03/10078

§ 371 Date: Sep. 19, 2005

(30) Foreign Application Priority Data
Sep. 17, 2002 (DE) 102 46 223.6

(51) Int. Cl. G09G 5/00

(52) U.S. Cl. 345/184

(57) ABSTRACT

Operator control element for electronic equipment used for actuating sensors and a method for selecting functions contained in an electronic memory and for displaying the selected function using a cursor The task to develop a control element for actuating sensors as well as a method for the selection of functions contained in an electronic memory by means of the control element and for the cursor display of the functions selected with the control element was solved by having a control element shaped like a disc and being tiltable across an axis vertical to the surface of the control element and equipped with sensors reacting to a push or pull strain at the underside, the control element at its underside being equipped with ring-shaped spring elements that react to pressure and are coaxially arranged in a specified distance to its axis.

This invention describes the characteristic of a control element used for actuating sensors in order to enable a selection of functions stored in electronic appliances and the display of the selected function by means of a cursor with electronic appliances.

Disc-like control elements for switches are a common input device to actuate sensors and to control the cursor of electronic devices, as they allow rapid and precise positioning. The simple user interface, the tiny required space and the possibility of single-hand operation have contributed to the success of this concept. These control elements are shaped e.g. like a disc and can today be found among others on remote controls of video recorders, digital cameras and even electronic organizers and kitchen appliances such as microwave ovens.

In contrast to jog dials and rollers for cursor control, control elements shaped like discs are actuated by a sliding movement on the front. Because of this, they require more space than wheels or rollers, but they can be operated more precisely because of the longer travel distance.

According to the state of the art, disc-like control elements for the activation of sensors and for cursor control are mainly based on rotary pulse emitters. Other technologies such as potentiometers, selector switches and code discs are practically irrelevant, as they are significantly more complex and offer no advantages for the sensor activation and cursor control.

Rotary pulse emitters transform the rotating movement of a wheel into a rapid pulse sequence which is used to move a cursor forwards and backwards. A longer movement leads to a longer sequence of pulses that are counted and interpreted by a digital circuitry. Usually, the pulses are generated by two switches that are repeatedly closed during a rotary movement. Two switches are required to recognize the direction of the movement (forwards/backwards). Instead of switches, other pulse emitters are commonly used, such as opto couplers or magnet switches.

Rotary pulse emitters are well suited for a combination with electronic circuits, however they are linked to some problems in principle: First of all, discs based on them can only detect relative movements and not the position of the control element or the position of its activation. Secondly, during a rapid movement some pulses may get lost, because either the electric switches or the electronic circuitry cannot process these rapid pulse sequences fast enough. Thirdly, many disc-like control elements are subject to wear and tear after intensive use, because the switches are closed very often.

Instead of electromechanical switches, rotary pulse emitters can also be based on light barriers (opto couplers). The principle is similar, they too transform the rotary movement into digital pulses. Light barriers are not so subject to mechanical tear and wear as mechanical switches, however they require energy permanently and are prone to contamination (dirt). Also, a decreasing luminosity after a long operating time (typical for LED) can lead to a failure of the light barriers.

In the middle of 2002, an audio player was introduced that is operated with a disc 5 centimeters in diameter that contains a capacitive sensor. When a finger is moved over this circular sensor, the input medium responds similar to a electromechanical dial.

This capacitive sensor, whose technology is already widely in use in rectangular form with notebook computers, has advantages: Positioning is more precise than with rotary pulse emitters and the sensor is free from wear and tear. As there is no mechanical movement, the control element can easily be protected from intrusion of dirt.

On the other hand, the mechanically rigid construction brings about disadvantages in usability, as there is no tactile feedback. So the capacitive sensor requires a permanent monitoring of the display to check whether the actuation was successful. Operation without viewing is almost impossible. There are more disadvantages such as energy consumption and cost of manufacturing. There is the risk of inadvertent activation by a simple approach of a finger without touch or an activation through moisture such as fog or sweat.

Conversely, the capacitive sensor can hardly be used when a hand is covered by gloves or other accessories.

All in all, the use of a disc with capacitive sensor is only adequate for appliances that cost more, are larger and require more energy than a mobile phone. Such a disc can hardly be built with a diameter of less than 2 or 3 centimeters, because in principle the width of a finger in relation to a tiny disc would distort the measurement of finger movements.

There are also disc-shaped control elements that consist of four keys and can for example move a cursor into one of four directions. A smooth navigation is impossible, as the actuation on one side simply closes the electric circuit on that side. Such cursor discs are commonly used with mobile phones, TV remote controls and digital cameras.

Some implementations feature a fifth switch in the center of the disc, which can for example be used as an Enter key. This fifth key is however difficult to use and leads to errors, because the arrangement in the center of the disc leads to one of the switches on the side easily being closed by accident. Because of this, the implementation with five switches is not so widely used.

This is similar to some rare cursor discs equipped with eight switches at their borders to move a pointer in the appropriate direction. The risk of an accidental activation is significant here too, so that discs with four switches are preferred. More than eight switches can hardly be mounted under the border of such a disc.

To summarize, discs with switches at their border have the advantage that they can be built with low cost as they are based on the same technology as keys. For the same reason, such discs can easily be combined with existing key pads. On the other hand, the advantage of such key arrangements is very limited by comparison to stepless actuatable discs.

Accordingly, the operation of an appliance equipped with cursor keys is much more inconvenient and slower than those with rotatable control elements.

There are also joysticks that are implemented as a shape resembling a disc. The tilt of the disc resulting from mechanical pressure is registered by force sensors and transformed into a cursor movement. An elastic force returns the disc into its passive state when it is not actuated. As force sensors, e.g. FSR (Force Sensing Resistors) oder strain gauges or flexible potentiometers may be used. However, such discs cannot be rotated and the position of an activation is not registered, only the tilt matters.

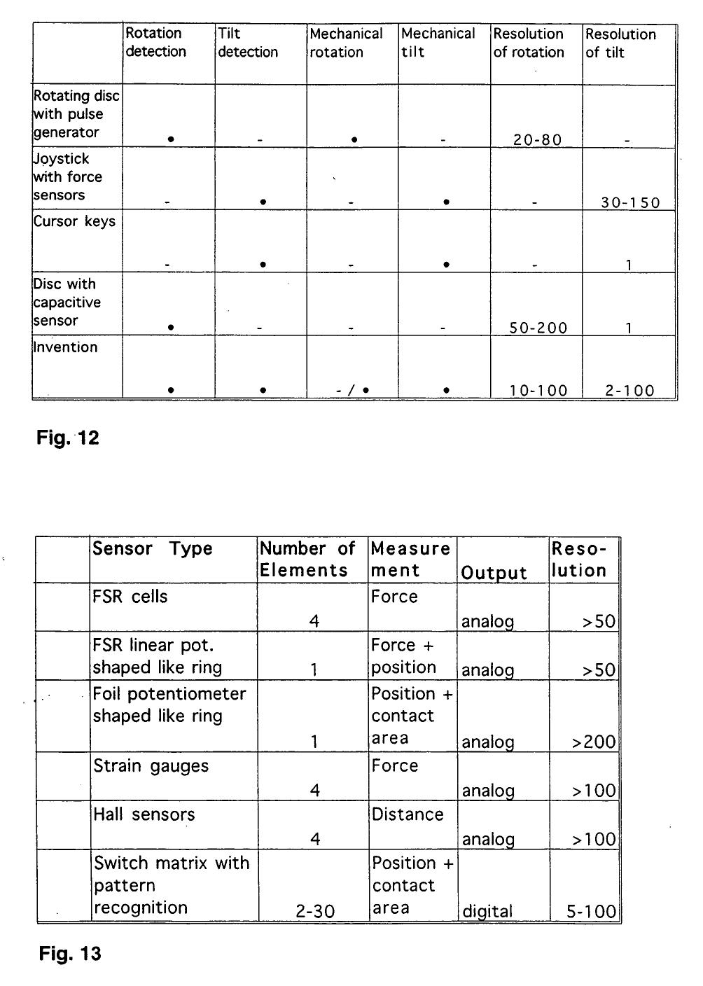

Some popular input devices are differentiated in the table of FIG. 12 according to their essential features and are distinguished to the invention. The first line makes clear that a dial with pulse emitters can indeed detect a rotating movement and is mechanically movable accordingly, but it cannot react to a tilt (pressure on the border).

A disc working like a joystick (line 2 of FIG. 12) can react to a tilt, but is not rotatable. A disc with a key cross is identical to a joystick with only a yes/no information for every direction instead of a stepless measurement. The disc with a capacitive sensor and without a mechanical rotation can precisely detect circular movements of a finger over the disc, but it cannot discriminate pressure levels.

A control element for actuating sensors that is also used for navigating a cursor of mobile electronic appliances should be simply and safely operable with a single hand even during vibrations e.g. during travel. The manufacturers of such appliances are interested in minimum space requirements for such a unit and a trouble-free production.

The invention is based on the task to develop a control element for the activation of sensors and a method for the selection of functions from an electronic memory by means of the control element and for the display of the functions selected with the control element by means of a cursor (highlighting).

This task has been solved with the technical solutions disclosed in the independent claims, the technical solutions disclosed in the dependent claims are intended to configure the invention.

This invention relates to the construction of a disc-shaped control element for the activation of a sensor and a method for the selection of functions from an electronic memory and for the cursor control of electronic appliances. Upon light pressure with a finger on the edge of the disc-shaped control element the edge travels slightly down, so that the vertical axis of the control element is minimally tilted. This tilt is evaluated by force sensors or angle sensors underneath the control element in order to calculate the position of the actuation of the control element. A sliding finger movement in a rotating direction on the surface of the control element leads to a changed direction of the tilt, which is interpreted by the sensors as a rotating movement. When the control element is let go, an elastic force affecting the control element returns it to its passive state.

Two implementations of the control element according to the invention are suggested. According to one implementation of the invention, there is a rotatable actuation disc mounted on this movable but not rotatable control element, where always only the tilt of the vertical axis caused by the sliding finger movement in a rotating direction on the surface of the control element of the actuation disc is evaluated.

A varying force on the edge of the control element according to the invention with a corresponding tilt of the vertical axis of the control element is used to control the speed of the cursor movement. A stronger force during a circular sliding movement on the surface of the control element leads to a more rapid movement.

As the sensors actuated through the control element not only detect a finger movement as a sliding movement in a circular direction, but also the finger position on the control element, the invention can also be used for data input. To this end, the edges of the control element according to the invention are assigned a repertoire of input values, so that a tap on the control element on a certain position leads directly to the selection of menu items or the input of characters. Additionally, the control element allows to select a direction by tapping it directly.

The invention makes an especially small, cost-effective and robust construction possible. It offers a new control element that recognizes the position and the force of an actuation, allowing both an adjustable cursor speed and data input.

The invention will be demonstrated by means of an example. The figures are as follows:

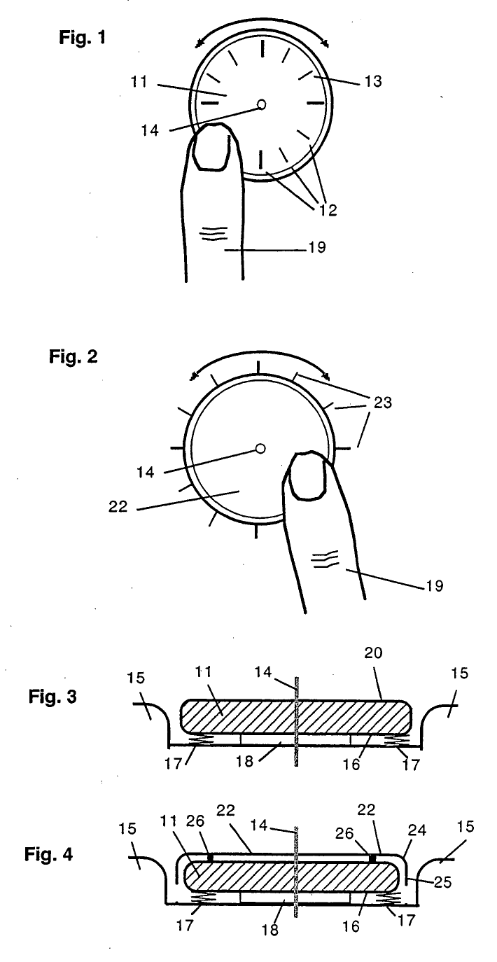

FIG. 1: a control element according to the invention in top perspective

FIG. 2: a control element according to the invention with a rotatable actuation disc mounted on it in top perspective

FIG. 3: a control element according to FIG. 1 in cross-section perspective

FIG. 4: a control element according to the invention with a rotatable actuation disc mounted on it in cross-section perspective

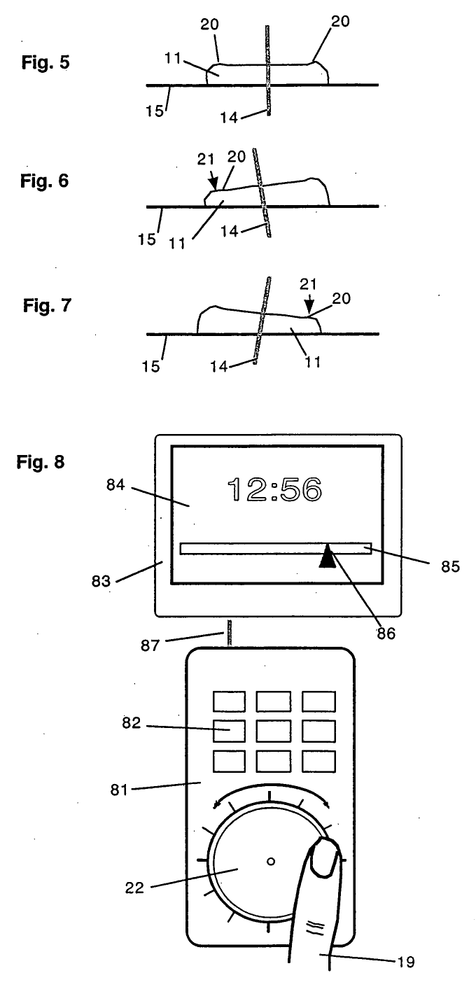

FIG. 5: position of the control element in passive state

FIG. 6: position of the control element during actuation on the left edge

FIG. 7: position of the control element during actuation on the right edge

FIG. 8: application example with an adjustable speed of the cursor movement

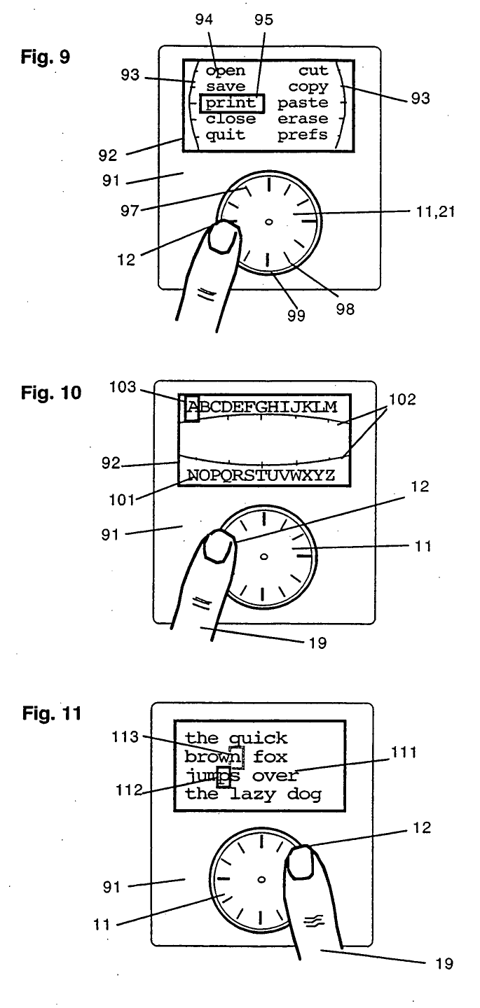

FIG. 9: application example menu selection with direct access

FIG. 10: application example letter input

FIG. 11: application example selection of a direction

FIG. 12: a comparison table of input technologies

FIG. 13: list of sensor types that can be used with this invention

FIG. 1 shows a control element 11 according to the invention with a footprint shaped like an area of a circle, which is equipped with twelve tick marks 12 similar to a clock face. In the following, the text relates to the position of the tick marks 12 like an hour hand of a clock, e.g. the tick mark 13 is at two o' clock position. Four of the tick marks, namely those in 12, 3, 6 and 9 o' clock position are emphasized slightly against the others. The control element 11 is tiltable against a vertical axis 14 and is positioned movable within an appliance casing 15, but not rotatable. Underneath the control element 11 at the underside 16 of the control element 11 there is a specific number of springs 17 arranged coaxially around the axis 14, the control element 11 being movable against the forces of the springs 17. The springs 17 are effective as separate springs, allowing the control element 11 to perform tilting movements around the axis 14. Underneath the control element 11 at the underside 16 there are also the actuatable sensors 18, which are connected to the control element 11. These sensors 18 register the mechanical actuation of the control element 11 and can be mounted underneath the control element 11 either at the center, at the edge or distributed over the complete area.

The control element 11 is actuated with the finger 19 of an operating person who is not shown. The displayed control element 11 has a circular surface 20. The operating person moves his or her finger 19 sliding or by repeatedly pressing different positions of the control element 11. This presses the control element 11 against the elastic force of one or more springs 17 so that it is tilted against its axis 14. This impinges at least one sensor 18. In its passive state the control element 11 stands as shown in FIG. 5 so that the imaginary axis 14 is aligned vertically to the appliance casing 15. During actuation (FIG. 6) at the left side of the operating element 11 the edge of the control element 11 sinks to the left into the appliance casing in order to follow the actuation pressure, and the axis 14 is tilted. If the control element 11 has a diameter of between 15 and 40 millimeters, the edge area 21 could travel approx. 0.5 to 2 millimeters. FIG. 7 shows the corresponding actuation on the other, right side of the control element 11. Such an actuation is possible at any position of the surface 20 of the control element 11.

FIG. 2 shows the control element 11 according to the invention in another implementation. This implementation is based on the described execution of the control element 11. This not rotatable control element 11 is equipped with an additional component, a rotatable actuation disc 22 that is mounted on the control element 11. This makes it possible to actuate the control element 11. With the implementation shown in FIG. 1, the finger 19 is moved like a slider on the surface 20 of the control element 11. If another component is added, the rotatable mounted actuation disc 22, the finger 19 of the operating person can continuously touch the same point and can actuate the actuation disc 22 with his or her finger 19 with a rotating movement, stressing and thus impinging the control element 11 according to the invention at several positions.

With this implementation of the control element 11 as shown in FIG. 2 with an actuation disc 22, which is rotatable just like other known dials physically around its axis 14, the tick marks 23 are fixed to the appliance casing 15 of the appliance that is not shown. Therefore, the tick marks 23 always stay at the same position.

From a horizontal cross-section perspective (FIG. 3), the control element 11 is buried in the appliance casing 15 of the electronic device. The surface 20 of the control element 11 including a rounded edge 24 is easily reachable with a finger 19, while a border area 25 that is vertical to the surface 20 is not accessible. This is because an actuation of this border area 25 would have no effect with the control element 11 according to the invention. Instead, actuations of the surface 20 of the control element 11 with a light force (less than 40 grams) leads to a tilt of complete control element 11, so that the axis 14 of the control element 11 is tilted a bit to its side. The surface 20 of the control element 11 in the non-rotatable implementation, i.e. fixed but tiltable, must be so smooth that the finger 19 can effortlessly slide on it. An actuation in the center of the control element 11 only leads to a reaction if it tilts the control element 11 slightly.

The control element 11 implemented with an actuation disc 22 that is mounted rotatable on the control element 11 is basically identical. With this implementation of the invention, the control element 11 receives an additional cap-like rotatable actuation disc which can slide or roll on the control element 11. The applied force is then transmitted with a transmission element 26 onto the actual control element 11, the transmission element 26 being shaped like a ring and arranged coaxial to the axis 14. It is only important that the cap-like actuation disc 22 can easily be rotated around the axis 14 and reliably transmits any finger pressure to the control element 11.

The only purpose of the cap-like actuation disc 22 is to simplify the operation resp. creating the illusion that a rotation had a real effect. Indeed, not the rotation of the cap-like actuation disc 22 triggers any functions, but the minimal tilt of the control element 11 at the position it is touched. A rotation of the cap-like actuation disc 22 without any pressure on it would have no effect at all.

As there is always some minimal friction of the rotary mechanism, the cap-like actuation disc 22 can only be moved on the control element 11 with a certain minimum force. This ensures a minimum tilt of the control element 11 at the position it is touched.

In contrast to the surface 20 of the non-rotatable control element 11, the rotatable cap-like actuation disc 22 is not required to have a smooth surface, it can instead be equipped with a rubber-like coating or a riffle.

The following explanations are relevant to both implementations of the invention if not mentioned otherwise, as their construction and operation are identical apart from the cap-like actuation disc 22.

The sensors 18 which are placed in the casing underneath the control element 11 and coupled mechanically with the control element 11 measure the actuation force 21 on the surface 20 of the control element 11.

A number of established technologies are available for the sensors 18:

Force Sensing Resistors (FSR), strain gauges, or hall sensors are already commonly used to measure the actuation of joysticks etc. A novel, digital tilt sensor is well suitable for this application.

FIG. 13 lists some sensor types that can be used with this invention. Single FSR cells can be mounted on four opposite points underneath, i.e. on the underside 16 of the control element 11. The actuation force 21 onto the edge of the control element 11 leads to an uneven resistance change within the four FSR cells, allowing to calculate the position of the activation. This application is known for TV remote controls etc., however only the joystick function without any rotary movements.

Instead of single FSR cells, a strip-like FSR sensor can be placed like a ring underneath the control element 11 in order to detect the position and the force of a tilt.

In a simplified version, a ring-shaped foil potentiometer without force sensor can register the position of an actuation under the disc edge. A foil potentiometer consists of a foil coated with a graphite layer with high electrical resistance (range of approx. 1 kiloohm up to 100 kiloohms), another foil that is coated with a layer with low electrical resistance (e.g. silver, resistance in the range of 5 ohms up to 1000 Ohms) and a spacer in between, which keeps both layers at a small distance (approx. 0.01 mm up to 0.2 mm). A mechanical pressure on any position of the ring leads to an electrical contact, allowing to calculate the position of the activation from the electrical resistance between the foils.

Such foil potentiometers are known shaped like rings, but only to detect angle positions, not to detect the tilt of a control element 11. The degree of the tilt can be derived in this case from the length of the touching area of both foils.

Strain gauges and hall sensors are known sensor technologies that can measure a force applied laterally onto a control element 11.

A new digital sensor has already been suggested that can be conveniently used with the control element 11 according to the invention suggested here to actuate a sensor.

The invention can be employed versatile to control electronic devices. FIG. 8 shows a remote control 81 for a video recorder with an implementation of the control element 11 according to the invention with an actuation disc as shown on FIG. 2. The remote control operates a video recorder whose functions are shown on a display unit 83. The display 84 contains among others a time axis 85 with a cursor 86 that can be navigated by actuating the actuation disc 21. Such applications are known on the basis of rotary pulse emitters e.g. in order to select and cut scenes of a video film.

The control element 11 according to the invention without and with a rotatable actuation disc 22 allows a significant extension of the well-known dial in this context. Depending on the force that is applied to the edge of the surface 20 of the control element 11, the speed of the movement depends on the size of the displayed cursor, i.e. on the force 21 applied to the edge of the surface 20 of the control element 11. In order to ensure a smooth movement, the measurement of the actuation force 21 is averaged around an interval of approx. 1 to 3 seconds. It is sufficient to differentiate between two and five levels of pressure.

The variable speed control allows both a very rapid and a precise movement with a single finger. It solves the usability problem that exists with rotary pulse emitters when fast movements should be detected.

As the control element 11 according to the invention does not only differentiate different levels of force, but can also detect the position of its actuation, new possibilities come along.

FIG. 9 shows a mobile electronic appliance 91 with a display 92, where the software displays on both sides a curved line 93 with tick marks that are associated with a number of menu items 94. When the control element 11 is actuated, a cursor 95 appears, the position of this cursor 95 being related to the actuation position on the control element 11. Pressing the control element 11 at the 11 o' clock position 97 would select the menu item “open” in this example, the 5 o' clock position would place the cursor at “prefs” and an actuation at 12 o' clock or 6 o' clock would have no effect.

Such an application is impossible with conventional discs. For instance, the invention allows to select menu items with a single press on a defined position of the edge of the surface 20 of the control element 11. The tick marks help to make the desired selection.

Text input is an often-requested function of electronic devices, where a disc should be used if there is no full keyboard available. Conventional discs require users to perform long rotary movements to enter each character, as conventional rotary pulse emitters understand only relative movements.

The invention offers a much faster input of characters. FIG. 10 shows a letter repertoire 101, where two curved lines 102 produce the visible relation to the control element 11 according to the invention. For instance, the actuation of the control element 11 according to the invention just before the 10 o' clock position 104 places a letter highlight 103 onto the letter “A”, with the 12 o' clock position onto “G” etc. As long as the control element 11 is touched, the position of the highlight may still be changed by a rotary movement. This allows to target specific letters in spite of the relatively vague tick marks.

Should the position of the actuation not match the intention exactly, then the selection may still be corrected. The selected input only becomes valid when the disc is released. The control element 11 achieves this because it can differentiate touch and release while conventional discs cannot.

The invention can also be used to enter an angle directly and without any rotation, i.e. to operate a navigation system. FIG. 11 demonstrates this feature in order to navigate the cursor 112 of a text editor 111 into arbitrary directions. In this example, pressing the 1 h 30 min position 114 moves the cursor from the position 112 into north-east direction into position 113. In this manner, the control element 11 can be used like a cursor keypad and can even position a mouse pointer in any direction, where an increased pressure can lead to a faster movement. The invention thus allows to navigate a two-dimensional object or cursor on a surface, whereas discs normally only allow navigation in one dimension (point on a line).

These applications make clear that the invention offers all functions of conventional discs with rotary pulse emitters and much more.

With rotary discs, either the edge or the axis is a weak spot for trouble through contamination or moisture. As one implementation of the invention can detect finger movements on a surface without requiring any mechanical rotary movement, the invention allows to build robust and even water-proof control elements 11 as a replacement for conventional discs.

The evaluation of the applied force at the edge of the control element 11 allows a variable speed control that is intuitively comprehensible and makes it possible to select longer distances much faster.

As the position of the actuation is recognized, a menu selection and a character input function with direct access at the edge of the surface 20 of the control element 11 can be implemented. The operation is also simplified by the fact that the invention can react upon an actuation and release of the control element 11. In addition, the control element 11 can function similar to a cursor keypad for a stepless input of directions. Conventional discs on the basis of rotary pulse emitters cannot offer any of these functions.

### LIST OF ITEMS

11 control element
12, 13 tick mark
14 axis
15 appliance casing
16 underside of control element
17 spring
18 sensor
19 finger
20 surface of control element
21 actuation force
22 actuation disc
23 graduation
24 edge
25 border area
26 transmission element
27 surface transmission element
81 remote control
83 display unit
84, 92 display
81 remote control
85 time axis
86 cursor
91 mobile electronic appliance
92 display
93 curved line
94 menu item
97, 98, 112, 113 position
101 letter repertoire
102 line
103 letter highlight
104 ten o'clock position
111 text editor

1. Control element for electronic appliances for the actuation of sensors for selecting and invoking functions stored in an electronic memory and for the display of the selected functions by means of a cursor on an electronic appliance, wherein the control element (11) is shaped disc-like and is tiltable around an axis (14) perpendicular to the surface (20) of the control element (11) and is equipped with sensors (18) reacting to pulling and/or compressive stress at its underside (16), the control element (11) being equipped at its underside (16) with spring elements (17) reacting to compressive stress arranged like a ring coaxially with a defined distance around the axis (14).

2. Control element according to claim 1, wherein the control element (11) is tiltable around the axis (14) and arranged axially manouevrable within the appliance casing (15).

3. Control element according to claim 1, wherein the control element (11) exhibits an outline similar to the area of a circle.

4. Control element according to claim 1, wherein the control element (11) is equipped with and attached to a rotatable actuation disc (22).

5. Control element according to claim 1, wherein the actuation disc (22) is rotatable around an axis (14) of the control element (11) and is pivoted and supported over transmission elements (26) on the surface (20) of the control element (11).

6. Control element according to claim 1, wherein the control element (11) exhibits a smooth surface (20).

7. Control element according to claim 1, wherein the actuation disc (22) exhibits a structured surface (20).

8. Control element according to claim 1, wherein the actuation disc (22) exhibits a geometric form tuned to the control element (11).

9. Control element according to claim 1, wherein the actuation disc (22) is shaped like a cap that is mounted easily rotatable on the control element (11).

10. Control element according to claim 1, wherein the control element (11) exhibits tick marks (12) consisting of twelve marks in regular intervals.

11. Control element according to claim 1, wherein the appliance casing (15) exhibits tick marks (23) next to the edge of the control element (12) consisting of twelve marks in regular intervals where the actuation disc (22) is arranged on the control element (11).

12. Method to actuate a sensor by means of a disc-shaped, fixed control element that is tiltable around an axis (14) perpendicular to the surface, wherein a light pressure with a finger onto the edge of the disc-like control element (11) moves it against a soft spring force (less than 40 grams) a bit downside, so that the perpendicular of the disc-shaped control element (11) is slightly moved into the direction of the actuation, this tilt being evaluated by means of force or tilt sensors in order to determine the position of the actuation of the control element (11), where a circular movement of the finger around the axis (14) on the surface (20) of the control element (11) leads to different directions of the tilt, which are recognized as a rotation and led to a micro processor that brings on a cursor movement according to the direction of the finger movement on the surface of the control element.

13. Method according to claim 12, wherein a stronger pressure during the actuation along the edge of the control element (11) leads to a faster cursor movement and a weaker pressure along the edge of the control element (11) leads to a slower cursor movement.

14. Method according to claim 12, wherein a menu is selected by actuating the edge of the upper side of the control element (11), the position of the actuation on the control element (11) leading to a highlighting of a menu item at the corresponding position on a display (84, 92).

15. Method according to claim 12, wherein a character repertoire is displayed upon actuation of the outer edge of the upper side of the control element (11), the position of the actuation on the surface (20) of the control element (11) leading to a highlighting of a character at the corresponding position on a display (84) and the most recently highlighted character is input when the control element (11) is released.

16. Method according to claim 13, wherein a sliding movement of the finger on the surface (20) of the con-trol element (11) is detected solely from the direction of the tilt of an axis (14) by means of force sensors or angle sensors.

17. Method according to claim 13, wherein the highlighting of a character can be selected by changing positions during the actuated state of the control element (11).

18. Method according to claim 13, wherein the character repertoire consists of the letters “A” to “M” at the upper edge of the screen and the letters “N” to “Z” at the lower edge of the screen.
